(19) United States
(12) Patent Application Publication
(10) Pub. No.: US 2007/0097699 A1
(43) Pub. Date: May 3, 2007

(54) Light-guiding structure having spring member and positioning portion for being assembled to a panel easily

(75) Inventor: Yung-Chin Hsu, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/262,277

(22) Filed: Oct. 28, 2005

(51) Int. Cl. G02B 6/00

(52) U.S. Cl. 362/551

(57) ABSTRACT

A light-guiding structure applied to a panel having a plurality of first engaging portions and a first positioning portion is disclosed. The light-guiding structure includes a main body, a plurality of light-guiding poles installed on the main body and having a plurality of second engaging portions for engaging with the first engaging portions of the panel, and at least a spring member installed on the main body and having a second positioning portion for engaging with the first positioning portion of the panel. The light-guiding structure is easy to be assembled and disassembled, without the use of any tools.

### BACKGROUND OF THE INVENTION

1. Field of the Invention

The present invention relates to light-guiding structures, and more particularly, to a light-guiding structure able to be applied to a panel of an electronic device.

2. Description of Related Art

With development of the science and technology, powerful electronic equipments have been widely used in our daily life and become one necessary part of our life. As to an enterprise, how to use these electronic equipments such as servers in a network environment to collect and manage information is particularly important.

The electronic equipments such as servers are usually mounted in a cabinet in a stack manner or side by side. A plurality of hard disk drives could be mounted in each of the servers and a required system could be installed in each of the hard disk drives.

Meanwhile, in order to secure internal circuit components or mechanical components, to prevent dust and to obtain a decorative effect, a housing or a panel is usually mounted on the server. The housing or panel is fixed to the server by a plurality of screws and screw holes formed in the server so that the housing or panel could be removed if needed such as for maintaining, testing or operating the server.

In an effort to maintain electronic equipment, a set of LEDs (Light Emitting Diodes) indicating status of different units in the electronic equipment are aggregated so that a user or technician could easily identify a failing unit according to a fault LED.

However, after a panel is mounted to the electronic equipment, the user or technician has to look through perforations formed in advance in the panel to identify a fault LED. Thus, it is difficult for the user or technician to precisely and quickly determine a fault occurrence of any of the units. To overcome this problem, a plurality of light-guiding columns is mounted to the panel so that light of the LEDs below the panel could be guided to the outside. In this way, the user or technician could clearly view the light of the LEDs and easily identify a failing unit according to a fault LED.

However, these light-guiding columns are usually fixed to the panel permanently and irremovably. Once the light-guiding columns are not available, the whole panel needs to be replaced, thereby resulting in high maintenance cost.

Therefore, there exists a need to provide a light-guiding structure that can be assembled and disassembled without the need of any tools.

### SUMMARY OF THE INVENTION

To overcome the above-mentioned drawbacks of the prior art, it is a primary objective of the present invention to provide a light-guiding structure that can be assembled and disassembled without the need of any tools.

It is another objective of the present invention to provide a light-guiding structure of low maintenance cost.

To achieve the above and other objectives, a light-guiding structure for a panel having a plurality of first engaging portions and a first positioning portion is provided. The light-guiding structure includes a main body, a plurality of light-guiding poles installed on the main body and having a plurality of second engaging portions for engaging with the first engaging portions of the panel, and at least a spring member installed on the main body and having a second positioning portion for engaging with the first positioning portion of the panel.

Each of the light-guiding poles is preferably to be pervious to light and is made of acryl. Each of the second engaging portions is preferably to be designed as a protrusion. The spring member is preferably integrated with the main body and is in the form of a leaf and in the shape of one selected from the group consisting of characters “U” and “V”, and a plurality of connected Us and connected Vs. In the preferred embodiment, the second positioning portion is a circular or a rectangular convex point. In another embodiment, the second portion is a recess corresponding to the first positioning portion.

In the present invention, elastic force generated by the spring member allows the light-guiding structure to be assembled and disassembled without the need of any tools. As a result, a user or technician is allowed to assemble and disassemble the light-guiding structure more quickly and conveniently. Accordingly, the problem that the light-guiding columns are mounted to the panel permanently and irremovably is solved.

Meanwhile, the light-guiding structure of the present invention can be easily replaced if needed such as when the light-guiding structure is too old or out of function. Compared with the prior art that needs to replace the whole panel in the same circumstance, the present invention reduces maintenance cost.

Other aspects and features will become apparent to those ordinarily skilled in the art upon review of the following description of the preferred embodiments of the present invention in conjunction with the accompanying drawings.

### BRIEF DESCRIPTION OF DRAWINGS

FIG. 1 is a front view of a light-guiding structure diagram of the preferred embodiment according to the present invention;

FIG. 2 is a schematic diagram of a panel to which the light-guiding structure shown in FIG. 1 is applied of the preferred embodiment according to the present invention;

FIG. 3 is a rear view of the light-guiding structure shown in FIG. 1;

FIG. 4 is an amplified view of the light-guiding structure shown FIG. 1;

FIG. 5A is a schematic diagram of the light-guiding structure shown in FIG. 1 and the panel shown in FIG. 2 after the light-guiding structure has been mounted on the panel; and

FIG. 5B is a partially amplified view of the assembled light-guiding structure and panel shown in FIG. 5A.

### DETAILED DESCRIPTION OF PREFERRED EMBODIMENTS

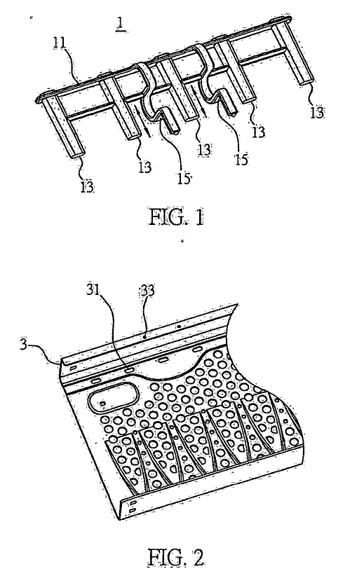

FIGS. 1 to 5B are diagrams according to the preferred embodiments of the present invention. For purpose of simplification and in order to make the characteristics and structure of the present invention more clear, the drawings merely show structures related to the present invention.

Referring to FIGS. 1, a light-guiding structure 1 comprises a main body 11, a plurality of light-guiding poles 13 and at least a spring member 15 installed on the main body 11. And referring to FIG. 2, a panel 3, to which the light-guiding structure 1 is applied, comprises a plurality of first engaging portions 31 and a first positioning portion 33. The following embodiment refers to a panel of a server, but it is only exemplary and the panel should not be limited thereto.

The main body 11 is designed according to a length of the panel 3 and is made of elastic material. In the present embodiment, the main body 11 is a whole piece to be assembled to the panel 3. But the main body 11 is not limited thereto. The length of the main body could be changed as long as it meets the requirement of the panel 3. In addition, a plurality of main bodies 11, that is, a plurality of light-guiding structures could be mounted on the panel 3.

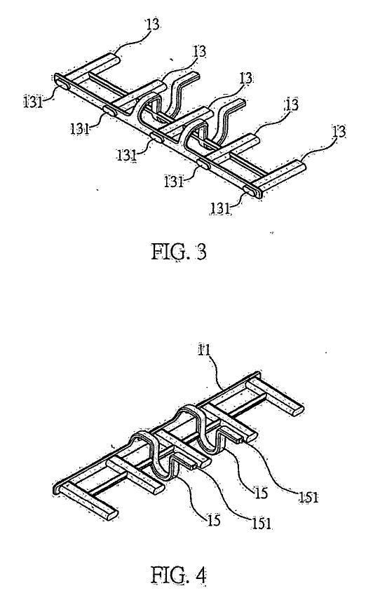

As shown in FIG. 3, each of the light-guiding poles 13 installed on the main body 11 has a second engaging portion 131 for engaging with its corresponding first engaging portions 31. In the present embodiment, the light-guiding poles 13 are arranged at positions spaced from each other and each of the light-guiding poles 13 is pervious to light and is made of acryl or the like. Each of the second engaging portions 131 is a protrusion, which is to be assembled to its corresponding first engaging portion 31 such as an opening. Accordingly, light of the LEDs (not shown) below the panel 3 could be guided to the outside so that the user or technician could manage or maintain the equipment according to the light.

The spring member 15 installed on the main body 11 has a second positioning portion 151 which could be elastically coupled to the first positioning portion 33. In the present embodiment, as shown in FIG. 4, a plurality of the spring members 15 are integrated with the main body 11. Each of the spring members 15 is a U-shaped leaf spring. The second positioning portion 151 is installed in a region on the spring member 15 far from the main body 1, and is a circular convex point corresponding to the first positioning portion 33, which is a circular opening.

Each of the spring members 15 could be a leaf spring of a V-shape, a continuous U-shape, a continuous V-shape or the like, as long as it can be elastically assembled to the panel 3. Meanwhile, each of the second positioning portions 151 is not limited to the circular point. Each of the second positioning portions 151 could be in any shape as long as it can be elastically assembled to the first positioning portion 33. For example, if the first positioning portion 33 is a rectangular hole, the second positioning portion 151 is a rectangular protrusion. If the first positioning portion 33 is a convex point, the second positioning portion 151 is a recess. In another word, structures of the first positioning portion 33 and the second positioning portion 151 are interchangeable and are not limited to the drawings.

Moreover, in the present embodiment, two spring members 15 are installed between every two neighboring light-guiding poles 13 after every four continuous light-guiding poles 13. But the number, structure and position of the light-guiding poles 13 are not limited thereto, which could be changed according to arrangement of the LEDs below the panel.

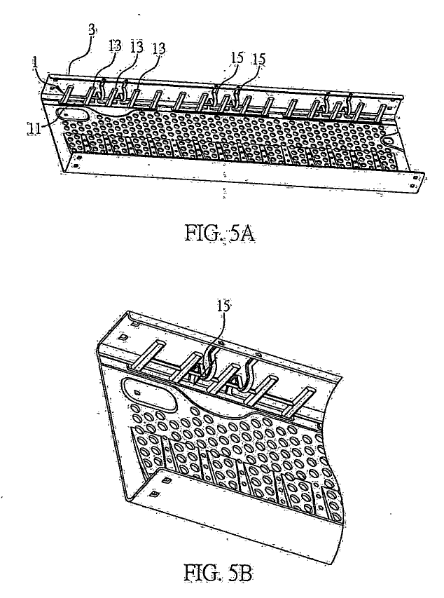

To mount the light-guiding structure 1 on the panel 3, what we only need to do is to assemble the second engaging portions 131 of the light-guiding poles 13 to the first engaging portions 31 of the panel 3 and assemble the second positioning portion 151 of the spring member 15 to the first positioning portion 33 of the panel 3, which needs not any tools. The final structure is shown in FIG. 5A and FIG. 5B.

As shown in FIG. 5A, the main body 11 is closely installed on an inner surface of the panel 3. Each of the light-guiding poles 13 installed corresponding to each of the LEDs below the panel 3 guides the light to a region outside of the panel 3.

As shown in FIG. 5B, while mounting the light-guiding structure 1 on the panel 3, each of the spring members 15 is compressed, and the elastic force generated by the spring members 15 allows the second engaging portions 131 to be firmly assembled to the first engaging portions 31 and the second positioning portion 151 to be firmly assembled to the first positioning portion 33. On the other hand, to disassemble the light-guiding structure 1 from the panel 3, elasticity of the spring member 15 makes it easy to separate the second engaging portions 131 from the first engaging portions 31 and separate the second positioning portion 151 from the first positioning portion 33.

As a result, the light-guiding structure could be assembled and disassembled easily and conveniently without the need of any tools, solving the problem of the prior art that the light-guiding structure is irremovably fixed to the panel.

In addition, such a light-guiding structure makes it easy to be replaced independently when it is damaged or deteriorated without the need of replacing the whole panel, thereby reducing the maintenance cost compared with the prior art.

Although a few preferred embodiments of the present invention have been shown and described, it would be appreciated by those skilled in the art that changes may be made in these embodiments without departing from the principles and spirit of the invention.

What is claimed is:

1. A light-guiding structure for a panel having a plurality of first engaging portions and a first positioning portion, the light-guiding structure comprising:
a main body;
a plurality of light-guiding poles installed on the main body and corresponding to the first engaging portions, each of the light-guiding poles having a second engaging portion for engagement of its first engaging portion of the panel; and
at least a spring member installed on the main body and having a second positioning portion for engagement with the first positioning portion of the panel.

2. The light-guiding structure of claim 1, wherein at least one of the light-guiding poles is pervious to light.

3. The light-guiding structure of claim 2, wherein the light-guiding pole is made of acryl.

4. The light-guiding structure of claim 1, wherein at least one of the second engaging portions is a protrusion.

5. The light-guiding structure of claim 1, wherein the spring member is integrated with the main body.

6. The light-guiding structure of claim 1, wherein the spring member is in the form of a leaf and in the shape of one selected from the group consisting of characters “U” and “V”, and a plurality of connected Us and connected Vs.

7. The light-guiding structure of claim 1, wherein the second positioning portion is a convex point.

8. The light-guiding structure of claim 7, wherein the convex point is circular or rectangular.

9. The light-guiding structure of claim 1, wherein the second positioning portion is a recess.

10. The light-guiding structure of claim 9, wherein the recess is circular or rectangular.
